(19) United States
(12) Patent Application Publication
(10) Pub. No.: US 2022/0248214 A1
(43) Pub. Date: Aug. 4, 2022

(54) System and Method for Network Traffic Analysis

(71) Applicant: Pelion IoT Limited, Glasgow (GB)

(72) Inventors: Ciaran Brendan McQuade, Glasgow (GB); Andrew Mackenzie, Glasgow (GB); Francesco Vanduynslager, Glasgow (GB); Moray Allan, Edinburgh (GB)

(73) Assignee: Pelion IoT Limited, Glasgow (GB)

(21) Appl. No.: 17/586,891

(22) Filed: Jan. 28, 2022

(30) Foreign Application Priority Data
Jan. 29, 2021 (GB) 2101248.9

(51) Int. Cl. H04W 8/22; H04W 8/02

(52) U.S. Cl. CPC H04W 8/22; H04W 8/02

(57) ABSTRACT

An automatic method of monitoring operation of a plurality of wireless connected devices comprising, at an analytics module, receiving information regarding operation of a plurality of wireless connected devices in disparate formats, analysing the received information regarding each of the plurality of wireless connected devices to generate analytical information regarding each of the plurality of wireless connected devices, and sending the generated analytical information regarding each wireless connected device to a rules module separate from the analytics module. Then, at the rules module, processing the generated analytical information for each wireless connected device using predetermined rules, and, based upon the results of the processing, sending instructions to carry out a SIM action for that wireless connected device, or a notification regarding that wireless connected device.

### BACKGROUND

The present disclosure relates to cellular telecommunications networks. More particularly, the present disclosure relates to performing network traffic analysis in cellular telecommunications networks.

There is increasing interest in wireless connected devices with wireless data connections, for example, for use as communication channels for the automatic reporting of data by the devices and sending of data and instructions to the devices. Such wireless connected devices and their connectivity are commonly referred to as the Internet of Things (IoT), and may also be referred to as machine to machine (M2M) communication.

In general, it is necessary to select a subscriber identity module (SIM) profile and tariff used by such wireless connected devices when they are deployed or activated based on estimates and predictions of their expected wireless communications needs. However, in operation of such wireless connected devices their actual wireless communications requirements may differ from what was anticipated, resulting in poor connectivity and/or excessive cost. Further, it is possible that some wireless connected devices may malfunction or perform in unintended ways, which may result in the transmission of large amounts of unwanted information and/or excessive cost.

### BRIEF DESCRIPTION OF THE DRAWINGS

Embodiments of the invention will be described, by way of example, with reference to the following drawings, in which:

FIG. 1 is an diagram of a general arrangement of a connectivity management platform (CMP) according to embodiments;

FIG. 2 is an explanatory diagram of a an activity analysis and connectivity management system useable in the CMP of FIG. 1;

FIG. 3 is an explanatory diagram of a method useable by the system of FIG. 2; and

FIG. 4 is an explanatory diagram of another method useable by the system of FIG. 2.

Common reference numerals are used throughout the figures to indicate similar features.

### DETAILED DESCRIPTION

As claimed in the Application Data Sheet, this application claims priority under 35 U.S.C. § 119(b) to foreign patent application number GB 21 01248.9, filed on Jan. 29, 2021, the content of which is incorporated herein by reference in its entirety.

Embodiments described below solve many of the problems described above. However the disclosure is not limited to solutions to these problems and some embodiments of the disclosure solve other problems.

The following summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In a first aspect, the present disclosure provides an automatic method of monitoring operation of a plurality of wireless connected devices, the method comprising: at an analytics module: receiving information regarding operation of a plurality of wireless connected devices in disparate formats, and analyzing the received information regarding each of the plurality of wireless connected devices to generate analytical information regarding each of the plurality of wireless connected devices; sending the generated analytical information regarding each wireless connected device to a rules module separate from the analytics module; at the rules module: processing the generated analytical information for each wireless connected device using predetermined rules, and, based upon the results of the processing, sending: instructions to carry out a SIM action for that wireless connected device; or a notification regarding that wireless connected device.

In a second aspect, the present disclosure provides a monitoring system for monitoring operation of a plurality of wireless connected devices, the system comprising: an analytics module arranged to: receive information regarding operation of a plurality of wireless connected devices in disparate formats; analyze the received information regarding each of the plurality of wireless connected devices to generate analytical information regarding each of the plurality of wireless connected devices; and send the generated analytical information regarding each wireless connected device to a rules module separate from the analytics module; and a rules module arranged to process the generated analytical information for each wireless connected device using predetermined rules; and send, based upon the results of the processing, instructions to carry out a SIM action for that wireless connected device; or a notification regarding that wireless connected device.

In a third aspect, the present disclosure provides a computer program comprising computer readable instructions which, when executed by a processor of a computer cause the computer to carry out the method of the first aspect.

The methods described herein may be performed at least in part by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the disclosure.

Embodiments are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

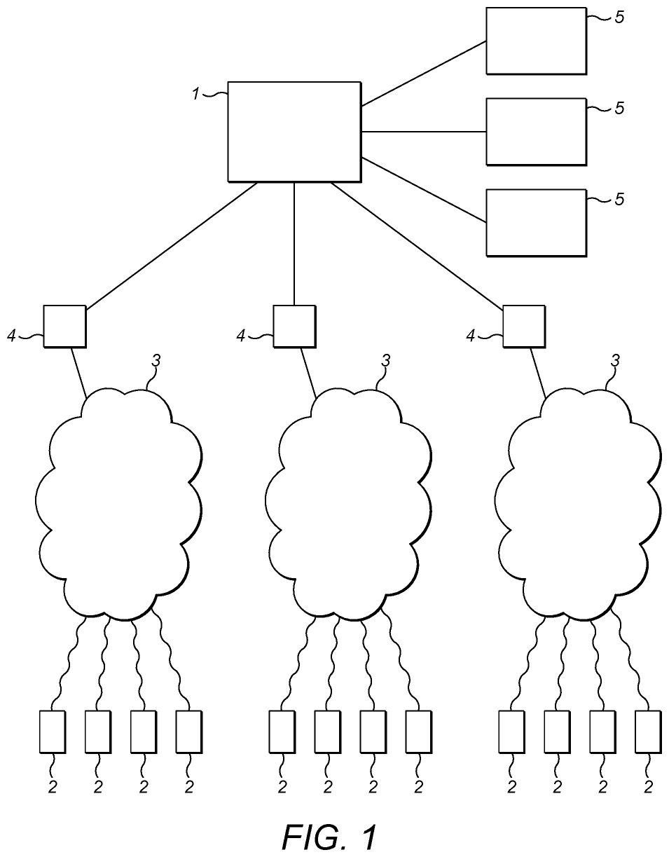

FIG. 1 shows a diagrammatic illustration of a connectivity management platform (CMP) 1 arranged to manage connectivity of a plurality of wireless connected devices 2 through a number of wireless communications networks 3 on behalf of a number of customers associated with different ones of the plurality of wireless connected devices. The plurality of wireless connected devices 2 are arranged for wireless connection to the wireless communications networks 3 to enable communication through the wireless communications networks 3 between the wireless connected devices 2 and the CMP1. The CMP 1 controls the wireless connectivity of the wireless connected devices 2. Further, the CMP 1 is arranged for communication with customer systems 5 associated with the customers whereby the CMP 1 acts as an intermediary and gatekeeper organizing and controlling communications between the wireless connected devices 2 and the customer systems 5. Accordingly, the CMP 1 enables communication between each wireless connected devices 2 and customer systems 5 according to requirements set by the customer associated with the wireless connected device 2 and the customer systems 5. Each wireless communications network 3 is operated by a mobile network operator (MNO) 4. The communications between the CMP 1 and the customer systems 5 may be carried by wireless or wired connections, as appropriate. The customer systems 5 may, for example, be servers 5 receiving and processing data from the wireless connected devices on behalf of the customers.

In the illustrated example the wireless connected devices are wireless communication devices and the wireless communication network is a cellular communications network. In other examples different types of devices and communications network may be used.

The wireless connected devices 2 may, for example, be devices arranged to provide Internet of Things (IoT) functionality or machine to machine (M2M) functionality. Accordingly, the wireless connected devices 2 may be referred to as an IoT devices or M2M devices.

In order to provide wireless connectivity, each of the wireless connected devices 2 comprises a SIM. In the illustrated example, these SIMs are Embedded Universal Integrated Circuit Card (eUICC) enabled SIMs, commonly referred to as eSIMs, which allow different eSIM profiles to be stored on a SIM, and to be remotely provisioned over the air to the eSIM. The different eSIM profiles stored on and/or remotely provisioned to each eSIM can then be used by the eSIM for communication with wireless communications networks, such as the wireless communications networks 3.

In the present application the term “eSIM” is used to refer to the eUICC enabled SIM, it should be noted that the term “eSIM” is also sometimes instead used to refer to the eSIM profiles.

In operation, the CMP 1 controls operation of the wireless connected devices 2 to ensure that the wireless connected devices 2 function in an efficient and desired manner. In the illustrated embodiment the CMP 1 is arranged to analyze the activity of each wireless connected device 2 and to automatically trigger an eSIM action at the wireless connected device based on the results of the analysis if necessary, as is explained in more detail below.

The triggered eSIM action may, for example, comprise changing the eSIM profile in use by the eSIM of the wireless connected device, shutting down the eSIM profile in use by the eSIM without replacement, or changing the MNO tariff associated with the eSIM profile. In some examples changing the eSIM profile may comprise replacing the eSIM profile in use with an alternative eSIM profile stored on the eSIM. In other examples changing the eSIM profile may comprise replacing the eSIM profile in use with an alternative eSIM profile provisioned over the air to the eSIM. This list is intended to be exemplary only, and is not exhaustive.

In some examples the CMP 1 may be arranged to analyze the activity of each wireless connected device 2 and to automatically issue communications to the customer associated with the wireless connected device 2 based on the results of the analysis if necessary, as is explained in more detail below.

Generally, each wireless connected device 2 acting as an IoT device or an M2M device will have anticipated or expected connectivity requirements depending upon the nature of the wireless connected device 2 and the functionality that it is expected to provide. These connectivity requirements may, for example, include the geographical area within which the wireless connected device 2 is expected to move in operation and the amount and/or rate of data which the wireless connected device 2 is expected to use (that is, receive and/or transmit) in operation. This may, for example be the total amount of data the wireless connected device 2 is expected to use in its operating lifetime, or the amount of data the wireless connected device 2 is expected to use in a given time, for example, daily, weekly or monthly. These examples are not intended to be exhaustive. Generally, the CMP 1 will arrange for each wireless connected device 2 to be commissioned with an eSIM using an eSIM profile associated with an MNO tariff supporting the anticipated or expected connectivity requirements of the wireless connected device 2.

In some circumstances a wireless connected device 2 may operate in an unexpected manner or malfunction so that the eSIM profile in use by its eSIM is unable to provide the required connectivity, or provides the required connectivity at unacceptably high cost. For example, a wireless connected device 2 may move to a location where the eSIM profile in use cannot provide connectivity with an acceptable quality of service (QoS). In another example, a wireless connected device 2 may move to a location where the eSIM profile in use provides connectivity through a wireless communication network 3 operated by an MNO 4 requiring the use of a roaming tariff, so that the operation of the wireless connected device 2 is unduly costly. In another example, the wireless connected device 2 may operate in an unexpected manner, for example due to a fault, and send an unexpectedly large quantity of data, so that operation of the wireless connected device is unduly costly.

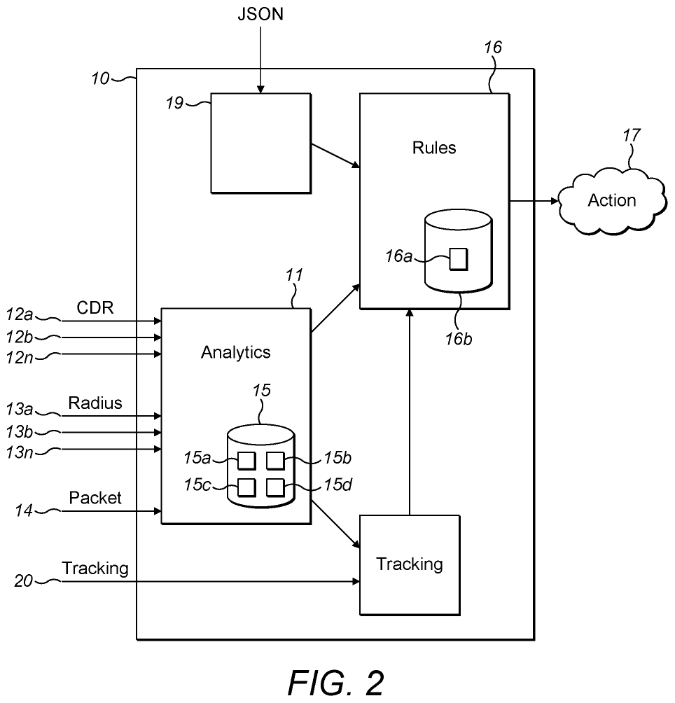

FIG. 2 shows a diagrammatic illustration of an activity analysis and connectivity management system 10 of a CMP 1 according to a first embodiment. The activity analysis and connectivity management system 10 provides activity analysis and connectivity management functionality for a CMP 1, and may be incorporated into the CMP 1, or may be separate from the CMP 1, as convenient in any specific implementation.

The activity analysis and connectivity management system 10 comprises an analytics module 11 and a rules module or rules engine module 16. The analytics module 11 receives and analyses information regarding network activity of the wireless connected devices 2 from number of different sources in disparate data formats, harmonizes the received information, carries out analysis of the information to generate analytical information, such as statistical information, regarding the activity of the wireless connected devices 2, and sends the statistical information to the rules engine module 16. The rules engine module 16 uses the statistical information provided by the analytics module 11, together with stored rules, to determine eSIM actions to be taken for different ones of the wireless connected devices 2, and sends instructions to carry out these eSIM actions to an action service 17.

The analytics module 11 receives a plurality of call detail record (CDR) streams 12. In the illustrated embodiment of FIG. 2 three CDR streams 12a, 12b and 12n are shown, this is not essential, and other examples may have a different number of CDR streams 12 corresponding to the number of MNOs 4. Each CDR stream 12 is provided by a different MNO 4 operating a respective wireless communications network 3, and comprises a series of CDR messages regarding wireless communications activity of the eSIMs of the wireless connected devices 2 controlled by the CMP 1 on that wireless communications network 3. Typically, CDR messages regarding a wireless communications network 3 are received periodically, for example about every 15 minutes. Typically, each CDR message comprises a plurality of CDRs, with each CDR comprising details of a single telecommunications transaction by a single wireless connected device 2 on the wireless communications network 3, so that each CDR message provides information regarding all telecommunications activity on the wireless communications network 3 by all of the wireless connected devices 2 controlled by the CMP 1 which has taken place since the previous CDR message. Typically, a CDR may comprise information such as time, duration of a call or amount of data used (i.e. transmitted and/or received), source, destination, and duration. However, the exact content and format of a CDR varies between different MNOs 4. The different CDR streams 12 are asynchronous because they are sent independently by the different MNOs 4.

Further, the analytics module 11 receives a plurality of Remote Authentication Dial-In User Service (RADIUS) message streams 13. In the illustrated embodiment of FIG. 2 three RADIUS message streams 13a, 13b and 13n are shown, this is not essential, and other examples may have a different number of RADIUS message streams 13 corresponding to the number of MNOs 4. Each RADIUS message stream 13 is provided by an different MNO 4 operating a respective wireless communications network 3, and comprises a series of RADIUS messages regarding RADIUS events relating to wireless communications connectivity of wireless connected devices 2 controlled by the CMP 1 on that wireless communications network 3. Typically, RADIUS messages from an MNO 4 regarding connectivity on a wireless communications network 3 of the MNO 4 are received periodically, for example about every 30 minutes. Each RADIUS message comprises a plurality of RADIUS events, with each RADIUS event comprising details of activity of an eSIM of a single wireless connected device 2 on the wireless communications network 3, so that each RADIUS message usually provides information regarding connectivity to the wireless communications network 3 by all of the wireless connected devices 2 controlled by the CMP 1 which has taken place since the previous RADIUS message. Typically, a RADIUS event may comprise information such as an eSIM of a wireless connected device 2 going on line, going off line, the amount of data used (i.e. transmitted and/or received), and where the eSIM connected to the network, for example the identity of the cell tower or base station the eSIM connected to. However, the exact content and format of a RADIUS event varies between different MNOs 4. It will be understood that the different RADIUS message streams 13 are asynchronous because they are sent independently by the different MNOs 4. Further, the CDR messages and the RADIUS messages are not asynchronous.

Typically, MNOs may provide both CDRs and RADIUS messages. However, some MNOs may provide only CDRs.

Further, the analytics module 11 receives a packet data stream 14. The packet data stream 14 is generated by another part of the CMP 1 based on analysis of the data packets passed between the wireless connected devices 2 and the customer systems 5. This analysis typically comprises the amount of data sent and/or received by each wireless connected device 2, and may also identify which customer systems 5 each wireless connected device 2 is communicating with. In order to reduce the volume of the packet data stream 14 the CMP 1 may generate an accumulated total or histogram of the data use by each wireless connected device 2 and send the accumulated result periodically. In some examples the accumulated result for a wireless connected device 2 or multiple wireless connected devices 2 may be sent ever minute as a packet data message. The CMP 1 may comprise a plurality of analysis elements located at different parts of the CMP 1 to analyze data packets associated with different wireless connected devices 2. Typically, the CMP 1 analyses the metadata of the data packets to determine which customer systems 5, such as servers 5, each wireless connected device 2 is communicating with and includes the results of this analysis in the packet data messages in the packet data stream 14. Typically, the packet data stream 14 does not include any information regarding the location of the wireless connected devices 2 or which wireless communications network they are connected to.

It will be understood that because they are generated in different ways and received by different routes the data received through the CDR streams 12, the RADIUS message streams 13, and the packet data stream 14 are asynchronous, even when the data relates to the same events and the same wireless connected device 2.

When the analytics module 11 receives a CDR message through a CDR stream 12 the analytics module 11 parses the CDR message to extract the information from the CDRs comprised in the CDR message, transforms the information as necessary into a first format, and stores the information in a data store 15 of the analytics module 11 in the first format in a CDR database 15a. Although the formats of the CDRs from different MNOs 4 may be different, the format of the CDRs of each MNO 4 is known. Accordingly, the necessary actions to transform the information for each MNO 4 into the first format is known to the analytics module 11 in advance. In some cases, some MNOs 4 may provide CDRs in the first format so that no transformation is required.

When the analytics module 11 receives a RADIUS message through a RADIUS message stream 13 the analytics module 11 parses the RADIUS message to extract the information from the RADIUS events comprised in the RADIUS message, transforms the information as necessary into a second format, and stores the information in the data store 15 in the second format in a RADIUS database 15b. Although the formats of the RADIUS events from different MNOs 4 may be different, the format of the RADIUS events of each MNO 4 is known. Accordingly, the necessary actions to transform the information for each MNO 4 into the second format is known to the analytics module 11 in advance. In some cases, some MNOs 4 may provide RADIUS events in the second format so that no transformation is required.

When the analytics module 11 receives a packet data message through the packet data stream 14 the analytics module extracts the information from the packet data message and stores the information in the data store 15 in a third format in a packet data database 15c. Since the packet data messages are generated by the CMP 1 itself, the information in the packet data messages will normally be generated and sent in the third format, so that no transformation of the extracted information is required. However, if the information in the packet data messages is not sent in the third format, for example if it is also used for another purpose requiring a different format, the analytics module may also transform the information as necessary into the third format.

The data relating to any particular wireless connected device 2 received through the different streams 12 to 14 should match up and be consistent over time, although there may be some apparent short-term inconsistencies due to the periodic and asynchronous delivery of data through the different streams 12 to 14.

The analytics module 11 has a number of analysis definitions relating to the different wireless connected devices 2 stored in the data store 15 in an analysis database 15d. Each stored analysis definition is stored in association with identity information specifying which wireless connected devices the defined analysis is to be applied to. Each stored analysis definition comprises information defining what stored data regarding a specific wireless connected device 2 is to be obtained from the databases 15a to 15c, how the obtained data is to be processed, and trigger conditions defining when a notification is to be sent to the rules engine module 16 based on the results of the processing. The processing may derive statistical information regarding the activity of the different wireless connected devices 2. The analytics module 11 is arranged to send notifications to the rules engine module 16 on a push basis when the trigger conditions are found to be satisfied.

In some simple examples, analysis definitions may relate to amounts of data used by a wireless connected device 2. For example a total amount of data used by a wireless connected device 2 in operation, or an amount of data used by a wireless connected device 2 over a specific time period, for example daily, weekly, or over a billing period. Accordingly, in these examples, when a trigger point value is reached or exceeded, the notifications sent to the rules engine module may indicate the amount of data used, or the trigger point value which has been reached or exceeded, in total, or over a specific period. In other examples more complex analysis definitions may be used to generate more complex statistical information regarding the network activity of the wireless connected devices 2. Such more complex analysis definitions may involve processing of multiple different parameter values derived from the different data streams. The analysis definitions and trigger points may be arbitrarily complex.

The rules engine module 16 has a plurality of stored rules and associated identity information specifying which wireless connected devices 2 each stored rule is to be applied to stored in a rules database 16a in a rules data store 16b. Each stored rule comprises the identity of the notification or notifications considered by the rule, and the values and/or decision making logic which will cause those notification(s) to satisfy, the rule, and the eSIM action or communication to be generated when the rule is satisfied.

An overview of the operation of the activity analysis and connectivity management system 10 is that the analytics module 11 analyses the information received through the different streams 12 to 14 based on the stored analysis definitions, and sends notifications to the rules engine module 16 when trigger conditions of the analysis definitions are satisfied. When the rules engine module 16 receives a notification from the analytics module 11, the rules engine module 16 processes the notifications using the stored rules and associated identity information to determine when the stored rules are satisfied, the eSIM action or communication to be generated when a stored rule is satisfied, and the wireless connected device 2 which the eSIM action or communication applies. The rules engine module 16 then sends appropriate instructions to carry out the eSIM action, and/or to send the communication, to an action service 17 to be actioned. Typically, communications will be sent to customers to inform them of the status of their associated wireless connected devices. However, communications may alternatively, or additionally be sent to other parties for action or information, for example to CMP personnel, such as internal support teams, and/or to external organisations, such as MNOs. Further, in examples where the ownership and/or control of the wireless connected devices is more complex, such as involving a hierarchy of different entities, each communication may be sent to any appropriate entity based upon the nature of the communication, as desired.

Splitting the functionality of the activity analysis and connectivity management system 10 between the analytics module 11 and the rules engine module 16 may allow the notifications, or other output regarding the results of the processing an analysis by the analytics module 11, to be provided to other parts of the CMP 1 in addition to the rules engine module 16. This may improve efficiency by reducing duplicated processing and analysis within the CMP 1.

Splitting the functionality of the activity analysis and connectivity management system 10 between the analytics module 11 and the rules engine module 16 may be architecturally advantageous. The analytics module 11 generally needs to hold a lot of data in working memory and to combine data from a number of different data sources. In contrast, the rules engine module 16 only needs to compare the numerical values indicated by the individual notifications received from the analytics module 11 to the rules for the various wireless connected devices.

In general, data is received through the different streams relatively quickly, so that this received data must be processed and analyzed by the analytics module 11 relatively quickly. In contrast, the carrying out of eSIM actions and the issuing of notifications to customers, for example by email or SMS, may take a significant amount of time, so that the processing by the rules engine module 16 may take place more slowly. Accordingly, splitting the functionality of the activity analysis and connectivity management system 10 between the analytics module 11 and the rules engine module 16 may allow the processing speed and capacity of the analytics module 11 and the rules engine module 16 to be better matched to their respective requirements, which may improve efficiency.

Splitting the functionality of the activity analysis and connectivity management system 10 between the analytics module 11 and the rules engine module 16 allows the rules engine module to be stateless, which may simplify the design and operation of the rules engine module 16.

In some examples the activity analysis and connectivity management system 10 may comprise a single the rules engine module 16 sending notifications to a plurality of separate distributed rules engine modules 16. This may allow each of the distributed rules engine modules 16 to be arranged at a suitable location for the execution of eSIM actions for particular subsets of the wireless connected devices 2. Splitting the functionality of the activity analysis and connectivity management system 10 between the analytics module 11 and the rules engine module 16 may facilitate dividing the rules engine module functionality between such a plurality of distributed rules engine modules 16.

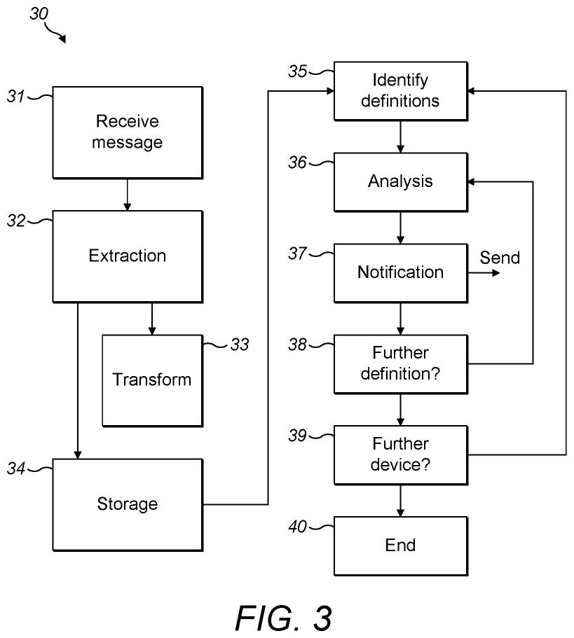

A flowchart showing an overview of method 30 according to a first embodiment which may be carried out by the analytics module 11 in operation of the activity analysis and connectivity management system 10 is shown in FIG. 3.

As shown in FIG. 3, the method 30 begins when the analytics module 11 receives a message through one of the CDR streams 12, the RADIUS message streams 13, and the packet data stream 14 comprising information regarding a number of the wireless connected devices 2, in a receive message block 31. Then, in an extraction block 32, the analytics module 11 extracts information from the received message.

If necessary, the analytics module 11 then transforms the extracted information in a transformation block 33. As is explained above, this may not be necessary if the extracted information is already in the desired format, such as the first to third formats.

Then, in a storage block 34, the analytics module 11 stores the extracted, and possibly transformed, information in a respective one of the databases 15a to 15c corresponding to the type of the message in association with information identifying the wireless connected device(s) 2 which the information relates to.

Then, in an identify definitions block 35, for a first one of the wireless connected devices 2 to which the extracted information relates, the analytics module 11 identifies any analysis definitions stored in the analysis database 15d associated with that wireless connected device 2. In some examples the analytics module 11 identifies any analysis definitions stored in the analysis database 15d which are associated with the wireless connected device 2 and have a trigger condition based, at least in part, on the extracted information.

Then, in an analysis block 36, the analytics module 11 carries out processing of the stored information relating to the wireless connected device 2 according to a first one of the identified analysis definitions stored in the analysis database 15d associated with the respective wireless connected device 2. If the processing in the analysis block 36 determines that a trigger condition of the analysis condition has been reached, the analytics module 11 sends a corresponding notification to the rules engine module 16 in a notification block 37. Otherwise, no notification is sent. The notification comprises the identity of the wireless connected device 2 to which the processed information relates and the trigger condition or other value reached, as specified in the analysis definition. In some examples, the analytics module 11 may store the results of the processing in the data store 15 for future use, whether or not a trigger condition is reached.

Then, in a further definitions block 38, the analytics module 11 determines whether there are any further analysis definitions stored in the analysis database 15d associated with the respective wireless connected device 2 which have not yet been processed. If there are further analysis definitions which have not been processed the analytics module 11 returns to the analysis block 36 and repeats the method for a next one of the analysis definitions stored in the analysis database 15d associated with the respective wireless connected device 2. Otherwise, the analysis module 11 proceeds to a further device block 39.

In the further device block 39, the analytics module 11 determines whether there are any further wireless connected devices 2 to which the extracted information relates which have not yet been considered. If there are further wireless connected devices which have not been considered the analytics module 11 returns to the identify definitions block 35 and repeats the method for a next one of the wireless connected devices 2 to which the extracted information relates. Otherwise, the analysis engine module 11 proceeds to an end block 40 and ends the method.

As is explained above, messages are received through the CDR streams 12, the RADIUS message streams 13, and the packet data stream 14 asynchronously. Accordingly, if messages are received before processing of a previous message has been completed, the analytics module 11 may store the received messages in a queue for subsequent processing.

In the example described above, the analytics module 11 processes each received message separately. It will be understood that each message may contain information regarding the activity of a wireless connected device 2 over a period of time, and that this period of time may vary, for example between different types of massage and different message sources, such as different MNOs. In other examples the analytics module 11 may operate by batch processing, where a number of messages are accumulated, for example over a predetermined number of messages, or a predetermined period of time, or a predetermined volume of data, and then process the accumulated messages. The use of batch processing may improve efficiency.

In some examples the different types of messages received through the different streams may be processed differently. For example, CDR messages and packet data messages indicating amounts of data used by different wireless connected devices 2 may be used to update total usage counts which are compared to analysis definitions only after a batch of messages have been processed. However, RADIUS messages regarding RADIUS events may be used to update records indicting the current connection states of the different wireless connected devices 2, and these current connection states may be compared to analysis definitions immediately when they change, or change in some predefined significant manner, such as the different wireless connected devices 2 coming on or off line. In general, it may be expected that a wireless connected device 2 coming on or off line may require a more urgent response than an amount of data used reaching a threshold, so that a different trade-off between efficient processing of the incoming messages and speed of response may be appropriate.

In some examples the analytics module 11 may be arranged to carry out blocks 31 to 34 separately from blocks 35 to 41. In some circumstances it may improve efficiency to separate the extraction, transformation and storage of information from the subsequent analysis of the stored information.

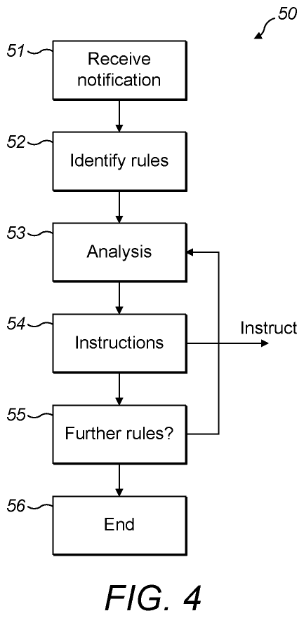

A flowchart showing an overview of method 50 according to the first embodiment which may be carried out by the rules engine module 16 in operation of the activity analysis and connectivity management system 10 is shown in FIG. 4

As shown in FIG. 4, the method 50 begins when the rules engine module 16 receives a notification from the analytics module module 11 in a receive notification block 51, the notification having been generated by the analytics module 11 in the notification block 37 of the method 30. Then, in an identify rules block 52, the rules engine module 16 identifies any rules definitions stored in the rules database 16a associated with the wireless connected device 2 and the trigger condition or other value reached identified in the notification.

Then, in an analysis block 53, the rules engine module 16 carries out processing of the notification relating to the wireless connected device 2 according to a first identified rule definition stored in the rules database 16a to determine whether the rule is satisfied. If the rule is satisfied, the processing in the analysis block 53 also identifies the action or actions to be taken in response to the notification for the wireless connected device 2 and then, in an instructions block 54, sends corresponding action instructions to the actions service 17.

Then, in a further rules block 55, the rules engine module 16 determines whether there are any further rules definitions stored in the rules database 16a associated with the wireless connected device 2 and the trigger condition reached identified in the notification which have not yet been processed. If there are further rules definitions which have not been processed the rules engine module 16 returns to the analysis block 53 and repeats the method for a next one of the rules definitions stored in the rules database 16a associated with the wireless connected device 2 and the trigger condition reached identified in the notification. Otherwise, the rules engine module 16 proceeds to an end block 56 and ends the method.

The action instructions sent by the rules engine module 16 to the actions service 17 identify an eSIM action to be carried out, together with the identity of the wireless connected device 2 which the eSIM action applies to, and/or a communication to be sent, together with the destination of the communication. In examples where the communication may be sent in multiple different ways, for example email or SMS, the action instructions may also identify how any communication is to be sent.

The actions service 17 then takes the necessary actions to carry out the instructed eSIM action for the identified wireless connected device 2, or to send the instructed communication, as appropriate. The necessary actions to carry out an eSIM action for a wireless connected device or to send a communication are well known. Accordingly, it is not necessary to discuss the operation of the actions service in detail herein.

As discussed above, eSIM action may, for example, comprise changing the eSIM profile in use by the eSIM of the wireless connected device, shutting down the eSIM profile in use by the eSIM without replacement, or changing the MNO tariff associated with the eSIM profile. In some examples changing the eSIM profile may comprise replacing the eSIM profile in use with an alternative eSIM profile stored on the eSIM. In other examples changing the eSIM profile may comprise replacing the eSIM profile in use with an alternative eSIM profile provisioned over the air to the eSIM.

The stored analysis definitions and stored rules may be set for individual wireless connected devices 2, or for groups of wireless connected devices 2 of any size. The stored analysis definitions and stored rules may, for example be based upon the intended function of the wireless connected devices 2 and/or the requirements of the customers associated with the devices. For example, a specific customer may define in advance conditions under which they require eSIM actions to be carried out and/or communications to be provided for their wireless connected devices having a particular function or properties, or for all of their wireless connected devices. A suite of analysis definitions and rules which will carry out the required eSIM actions and/or communications in these conditions can then be determined and stored in the activity analysis and connectivity management system 10, and associated with the wireless connected devices having a particular function. If the customer subsequently deploys wireless connected devices having the function, these deployed wireless connected devices can also be associated with the stored suite of analysis definitions and rules.

The present disclosure allows definitions and rules to be applied to individual wireless connected devices, or to groups of wireless connected devices based on any desired criteria, for example their function or the customer they are associated with. Other criteria may also be used.

The stored analysis definitions and rules and the identities of the associated wireless connected devices 2 may be amended, and new analysis definitions and rules and the identities added, by the operator of the activity analysis and connectivity management system 10. In operation of the activity analysis and connectivity management system 10 this will most commonly comprise associating the identities of newly commissioned wireless connected devices 2 with already stored analysis definitions and rules.

In some examples customers may be allowed to disable the sending of communications, or the taking of particular eSIM actions, for one, some, or all, of their wireless connected devices 2. This may, for example, be desirable where a device or group of devices is known to be operating in an anomalous or unexpected manner and it is not desired to receive repeated communications regarding this. To enable this the customers may be provided with lists of currently operating stored analysis definitions and eSIM actions and communications. The customers can then send instructions specifying which of these eSIM actions and/or communications are not to be carried out or sent, either permanently, or temporarily, for which wireless connected devices 2. In one example customers may send these instructions in the form of JSONs.

In some examples customers may be allowed to define new bespoke rules to be applied to their own wireless connected devices 2. To enable this the customers may be provided with lists of existing stored analysis definitions and available eSIM actions and communications. The customers can then use the existing stored analysis definitions as building blocks to define their desired rules and define which of the available eSIM actions and/or communications are to be carried out. Typically the customers may specify any desired content or destination for communications. In one example customers may provide new rules in the form of JSONs.

To support input of customer instructions and customer defined rules, the activity analysis and connectivity management system 10 may further comprise an automated rules manager module 19, as shown in FIG. 2. When the automated rules manager module 19 receives a customer JSON defining customer instruction or a new customer defined rule, the automated rules manager module 19 adds the instruction or new rule to the saved rules in the rules database 16a.

It will be understood that the inclusion of the automated rules manager module 19 is optional, and is not essential.

An example of a specific use case of the activity analysis and connectivity management system 10 is that the analytics module 11 has a stored analysis definition specifying that the total amount of data used by a wireless connected device 2 should be calculated, and that a notification should be sent regarding the wireless connected device 2 if a trigger condition is reached that the total exceeds a first predetermined value, the notification indicating the current total value. Further, the rules engine module 16 has a rule specifying that if a notification is received that a wireless connected device 2 has exceeded a second predetermined value, an eSIM action should be taken to shut down the eSIM profile in use by the eSIM of that wireless connected device 2. If the predetermined value is significantly larger than the total amount of data which is expected to be used over the operating lifetime of the wireless connected device 2 this may enable malfunctioning wireless connected devices 2 to be identified and shut down, possibly preventing a malfunctioning wireless connected device from incurring high data use costs, and preventing servers 5 being sent large amounts of useless data. In this case the rule may also specify that the customer associated with the wireless connected device 2 is sent a communication that it is malfunctioning and has been taken out of service. In a simple example the first and second predetermined values may be the same. In some more complex examples there may be a number of different rules with different second predetermined values, and indicating different actions to be taken, with only the rule having the highest second predetermined value specifying that the eSIM profile of the wireless connected device should be shut down.

Another example of a specific use case of the activity analysis and connectivity management system 10 is that the analytics module 11 has a stored analysis definition specifying that the amount of data used per month by a wireless connected device 2 should be calculated, and that a notification should be sent regarding the wireless connected device 2 if a trigger condition is reached that the total exceeds a predetermined value, the notification indicating the current amount value. Further, the rules engine module 16 has a rule specifying that if a notification is received that the amount of data used per month for a wireless connected device 2 reaches or exceeds the predetermined value, an eSIM action should be taken to change the eSIM profile in use by the eSIM of that wireless connected device 2 to a different eSIM profile which is more suitable for the higher level of data use. The rule may specify that the different eSIM profile is an eSIM profile is an eSIM profile already stored on the eSIM of the wireless connected device 2, or may instruct provisioning of a new eSIM profile over the air. This may enable wireless connected devices 2 to be provided with eSIM profiles suitable for their actual data use, possibly preventing a wireless connected device from incurring unnecessarily high costs. In this case the rule may also specify that the customer associated with the wireless connected device 2 is sent a communication that it is malfunctioning and has been taken out of service. In an alternative, the rule may instead specify that the MNO tariff associated with the eSIM profile should be changed. In some examples the rule may be more complex, and may indicate which of a number of possible different eSIM profiles and/or tariffs should be changed to depending upon the notified current amount value.

Another example of a specific use case would be for the analytics module 11 to identify which customer systems 5 each wireless connected devices 2 are sending data to, and for the rules engine module 16 to shut down the eSIM profile in use by the eSIM of a wireless connected device 2 and/or send a communication to the associated customer, if the wireless connected device 2 is sending data to an incorrect customer system 5, or to some other incorrect destination.

Another example of a specific use case would be for the analytics module 11 to predict that a wireless connected devices 2 will use a particular amount of data at some time in the future, such as an amount above that covered by a current agreement, and for the rules engine module 16 to respond to this by sending a communication to a customer asking if the customer wishes to purchase, or otherwise make available for use, further data for that wireless connected device 2.

The above are examples of use cases only, and it will be understood that many other use cases may be supported by the activity analysis and connectivity management system 10.

In a second embodiment the activity analysis and connectivity management system 10 further comprises a tracking module 18. The tracking module 18 may be used to support tracking services and provide additional functionality to the activity analysis and connectivity management system 10.

The tracking module 18 receives notifications from the analytics module 11 of location related events identified by analysis in the analytics module 11, and also receives tracking data through a tracking data stream 20. The tracking data indicates the location of specific wireless connected devices 2. This location will commonly be in the form of the identity of a cell tower or base station which the wireless connected device 2 is connected to, but may also take other forms. The tracking data may be generated by another part of the CMP 1, such as a no connection tracking service, or based on analysis of the data packets passed between the wireless connected devices 2 and the customer systems 5. The CMP 1 may analyze the metadata of the data packets to determine which cell tower or base station the wireless connected device 2 which is the source or destination of each data packet is connected to.

The tracking module 18 processes notifications from the analytics module and the tracking data and determines the locations of the various wireless connected devices 2. The tracking module 18 converts the determined locations, for example the identity of a specific cell tower or base station which a wireless connected device is connected to, into actionable location data indicating location in a form which is likely to impact connectivity and/or billing, which is a more suitable form for analysis and action. For example, the tracking module 18 may convert the raw location data into actionable location data indicating which country or MNO coverage region each wireless connected device 2 is located in.

Separating the tracking module 18 from the analytics module 11 may simplify the conversion of highly specific location data, such as cell tower or base station identities, into an actionable, and commercially and humanly meaningful, format. This may simplify the definition of rules which can be used to make changes which are significant in terms of connectivity of the wireless connected devices 2 and/or customer billing by the MNOs.

The tracking module 18 has saved criteria defining when changes in location of a wireless connected device 2 are to be reported. When these saved criteria are satisfied for a particular wireless connected device, the tracking module 18 sends a location change report to the rules engine module 16 indicating the new location of the wireless connected device 2.

In the second embodiment stored rules stored by the rules engine module 16 in the rules database 16a may further comprise location changes which will trigger the rule. Each stored rule may also specify eSIM actions or communications to be generated when the rule is triggered in dependence upon the current location of the wireless connected device 2. The actions service 17 then takes the necessary actions to carry out the instructed eSIM action for the identified wireless connected device 2, or to send the instructed communication, as appropriate.

An example of a specific use case of the activity analysis and connectivity management system 10 of the second embodiment is that the analytics module 11 has a stored analysis definition specifying that if a trigger condition is reached that the country in which a wireless connected device 2 is located changes a notification should be sent indicating the current country in which the wireless connected device 2 is located. The rules engine module 16 has a rule specifying that if a notification is received that a wireless connected device 2 moves into one of a list of specified countries, an eSIM action should be taken to shut down the eSIM profile in use by the eSIM of that wireless connected device 2. If the listed specified countries are countries having laws against sending information of the type being gathered by the wireless connected device 2, this may enable unintended law breaking to be avoided, and prevent servers 5 being sent data which cannot legally be processed. In this case the rule may also specify that the customer associated with the wireless connected device 2 is sent a communication that it is in the country identified in the notification, and has been taken out of service. In some examples the stored analysis definition may specify as a trigger condition that the wireless connected device 2 is identified as being located in a different country for a predetermined period of time before sending any notification, in order to avoid unnecessary action when a wireless connected device is merely near a national border where contact may be temporarily made with cell towers or base stations on the other side of the border.

Another example of a specific use case of the activity analysis and connectivity management system 10 of the second embodiment is that the analytics module 11 has a stored analysis definition specifying that the amount of data used by a wireless connected device 2 as a roaming eSIM should be calculated, and that a notification should be sent regarding the wireless connected device 2 if a trigger condition is reached that the total exceeds a first predetermined value, the notification indicating the current roaming data amount used value. Further, the rules engine module has a rule specifying that if a notification is received indicating that the current roaming data amount used value for a wireless connected device 2 has reached a second threshold value, an eSIM action should be taken to change the eSIM profile in use by the eSIM of that wireless connected device 2 to a different eSIM profile linked to an MNO providing network connectivity in the region where the wireless connected device 2 is currently located, as reported by the tracking module 18. The rule may specify that the different eSIM profile is an eSIM profile is an eSIM profile already stored on the eSIM of the wireless connected device 2, or may instruct provisioning of a new eSIM profile over the air. This may enable wireless connected devices 2 to be provided with eSIM profiles suitable for their location, possibly preventing a wireless connected device from incurring unnecessary roaming charges. In this case the rule may also specify that the customer associated with the wireless connected device 2 is sent a communication that the wireless connected device 2 has changed MNO. In an alternative, the rule may instead specify that the MNO tariff associated with the eSIM profile should be changed. In a simple example the first and second predetermined values may be the same. In some more complex examples there may be a number of different rules with different ranges of predetermined values, and indicating different eSIM profiles and/or MNO tariffs to be used depending on the current roaming data amount used value.

For simplicity, the description of the first and second embodiments set out above describes systems in which the analytics module 11 has fixed trigger conditions stored in the analysis database 15d for the various processed information regarding the wireless connected devices 2.

In some examples, the analytics module 11 may carry out processing and analysis of the stored data regarding the wireless connected devices 2 to determine the values of variable trigger conditions for the various processed information regarding the wireless connected devices 2. In such examples, wireless connected devices 2 may be grouped into groups of wireless connected devices 2 which are expected to operate in a similar manner. For example, these may be wireless connected devices 2 having the same, or similar, function, which may be expected to perform in a similar manner in service. In some examples, wireless connected devices 2 may be grouped together into groups based, at least in part on their being associated with the same customer.

In such examples, the processing carried out by the analytics module 11 may be used to identify wireless connected devices 2 which are behaving in a manner which is anomalous compared to other wireless connected devices 2 in the same group. For example, the average data usage amount of all of the wireless connected devices 2 in a group may be calculated, and a trigger condition variable value for the members of the group may be set based on this average amount. The trigger condition variable value may, for example, be set at 150% or 200% of the average amount. Any wireless connected devices 2 in the group having a data usage value meeting this trigger condition may be regarded as using excessive amounts of data, and potentially malfunctioning, and communications may be sent to the associated customer, and/or these wireless connected devices 2 may have their eSIM profiles disabled, as appropriate.

The example above compares activity by individual wireless connected devices 2 to average activity across a group of devices to identify anomalous behavior. In other examples the processing and statistical analysis used to identify anomalous behavior may be arbitrarily complex.

In further examples the analytics module 11 may be arranged to use the activity of a group of devices to predict the likely future behavior of the group of devices and compare

In another example, the change in location, that is, the movement, of all of the wireless connected devices 2 in a group may be monitored, and a trigger condition for the members of the group may be set to identify wireless connected devices 2 which move significantly more, or significantly less than a usual amount for the wireless connected devices 2 in the group. Any wireless connected devices 2 in the group having meeting this trigger condition may be regarded as operating in an unusual manner, and the associated customer may wish to be notified so that they can investigate this. For example, if a group of wireless connected devices 2 are smart meters, a wireless connected device 2 of the group contacting a number of cell towers or base stations at separated locations would could be identified as behaving in an anomalous manner.

In some examples, other, more complex analysis may be used instead of an average to identify wireless connected devices 2 exhibiting unusual behavior. This more complex analysis may comprise statistical analysis.

In the examples above, the rules engine module 16 may comprise stored rules specifying actions to be taken regarding any wireless connected devices exhibiting unusual and/or anomalous behavior.

In some examples the analysis definitions and rules may be arranged to predict that a wireless connected device 2 will meet some criterion in the future. For example, exceed a data usage threshold, and the associated customer may be notified to give them the opportunity to change the threshold.

In some examples, the wireless connected devices 2 may be arranged into groups, or wireless connected devices 2 may be assigned to groups, by the activity analysis and connectivity management system 10 based upon an analysis of the activity of the individual wireless connected devices 2.

In operation, the activity analysis and connectivity management system 10 can be used to detect device failures and manage trends or changes in activity of a large number of wireless connected devices 2. In some examples the communications generated by the activity analysis and connectivity management system 10 may be used to compare the performance of different types of wireless connected devices 2, such as devices having different hardware or software versions, and to identify devices or versions having problems. Further, the activity analysis and connectivity management system 10 may be used to analyze and breakdown performance of the wireless connected devices and to predict the likelihood of wireless connected devices performing within nominal ranges.

In the examples set out above, the activity analysis and connectivity management system 10 analyses the activity of the wireless connected devices 2, and applies rules to the results of the analysis to generate instructions to carry out eSIM actions for the wireless connected devices 2, or communications regarding the wireless connected devices 2, based upon the analysis and rules. In other examples the activity analysis and connectivity management system 10 analyses the activity of the wireless connected devices 2 to determine that there are issues with the wireless connectivity provided by the different wireless communication networks, and apply rules to the results of the analysis to generate communications regarding the wireless communication networks based upon the analysis and rules. Such communications may be sent if it is determined that there are wireless connectivity problems with particular networks, or in particular geographical locations, or with particular types of wireless traffic.

The use of an eSIM in the wireless connected devices is not essential. The eSIM may be replaced by any type of SIM. In alternative examples the SIM may be a physical SIM card or a iSIM. An iSIM is provided by software allowing eSIM profiles to be supported by, and remotely provisioned over the air to, a processor having the necessary capabilities and functionality to support the operation of the eSIM profiles. In some cases the type of SIM used may limit the range of actions which may be carried out by the activity analysis and connectivity management system 10 in respect of a wireless connected device.

In the embodiments described above the system receives CDR streams, RADIUS streams, a packet data stream, and in the second embodiment also a tracking data stream. In other examples different numbers and types of data streams may be used. In other examples the timings and formats of the messages in the message streams may be changed.

In the embodiments described above the activity analysis and connectivity management system 10 is shown as a unitary device. In other examples this may be a distributed system.

In the embodiments described above, the data store 15 is a part of the analytics module 11. In other examples the data store 15 may be separate from and connected to the analytics module 11.

In the embodiments described above, the rules data store 16b is a part of the rules engine module 16. In other examples the rules data store 16b may be separate from and connected to the rules engine module 16.

In the embodiments described above, the databases 15a to 15d are in the same data store 15. In other examples, these databases may be in a plurality of separate data stores.

In the embodiments described above, the databases 15a to 15d are separate databases. In other examples, these databases can be combined.

In the embodiments described above, the analytics module 11 sends notifications to the rules engine module 16 on a push basis. The use of a push mechanism may avoid any need for the rules engine module 16 to continually query the analysis engine module 11 to determine whether a trigger condition has been reached on each wireless connected device. In other examples the notifications may be sent on a pull basis.

The embodiments described above store data before analyzing the stored data. In other examples some, or all, data may be analyzed “live” before it is stored.

The embodiments described above are described as being automatically carried out without human intervention. In other examples some human decision making may be involved.

In the described embodiments of the invention the system may be implemented as any form of a computing and/or electronic device.

Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The computer executable instructions may be provided using any computer-readable media that is accessible by computing based device. Computer-readable media may include, for example, computer storage media such as a memory and communications media. Computer storage media, such as a memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media.

Although the access control service and the authorization server are each shown as separate single devices it will be appreciated that either or both may be distributed or located remotely and accessed via a network or other communication link (e.g. using a communication interface). Further, the access control service and the authorization server may be combined in a single device.

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

The order of the elements of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this disclosure.

What is claimed is:

1. An automatic method of monitoring operation of a plurality of wireless connected devices, the method comprising:
at an analytics module:
receiving information regarding operation of a plurality of wireless connected devices in disparate formats, and
analysing the received information regarding each of the plurality of wireless connected devices to generate analytical information regarding each of the plurality of wireless connected devices;
sending the generated analytical information regarding each wireless connected device to a rules module separate from the analytics module; and
at the rules module:
processing the generated analytical information for each wireless connected device using predetermined rules, and
sending, based on said processing, instructions to carry out a subscriber identity module (SIM) action for that wireless connected device or a notification regarding that wireless connected device.

2. The method of claim 1, further comprising, at the analytics module, harmonizing the received information.

3. The method of claim 1, further comprising:
sending location related generated analytical information regarding each wireless connected device to a tracking module separate from the analytics module and the rules module; and
at the tracking module:
processing the location related generated analytical information for each wireless connected device to determine a location of that wireless connected device,
comparing the determined location to predetermined criteria, and
sending, based on said comparing, determined location information to the rules module,
where the rules module processes the determined location information together with the generated analytical information for each wireless connected device using predetermined rules.

4. The method of claim 3, where the tracking module further receives tracking information regarding the plurality of wireless connected devices, and processes the tracking information together with the location related generated analytical information to determine locations of the wireless connected devices.

5. The method of claim 1, where the analytical information regarding each of the plurality of wireless connected devices is statistical information.

6. The method of claim 1, where:
the plurality of wireless connected devices are arranged into groups of multiple wireless connected devices;
the analytics module is further arranged to:
analyse the received information regarding each of the multiple wireless connected devices in a group to generate statistical information regarding the group of wireless connected devices, and compare the generated analytical information regarding a wireless connected device in the group to the statistical information regarding the group of wireless connected devices, to identify whether the wireless connected device is operating in an anomalous manner compared to the group of wireless connected devices, and
if the wireless connected device is operating in an anomalous manner, send information that the wireless connected device is operating in an anomalous manner to the rules module,
the rules module is further arranged to process the information that the wireless connected device is operating in an anomalous manner together with the generated analytical information for the wireless connected device.

7. The method of claim 1, where the SIM is an Embedded Universal Integrated Circuit Card (eUICC) enabled SIM (eSIM).

8. The method of claim 1, where the SIM action comprises one or more of:
changing a SIM profile in use by a SIM of the wireless connected device;
shutting down the SIM profile in use by the SIM of the wireless connected device;
changing a tariff associated with the SIM profile of the wireless connected device; and
provisioning a new SIM profile over the air to the SIM of the wireless connected device.

9. The method of claim 1, where the generated analytical information regarding different wireless connected devices is sent to different ones of a plurality of distributed rules modules.

10. A system for monitoring operation of a plurality of wireless connected devices, the system comprising:
a processor configured to execute an analytics module and a rules module,
where the analytics module is configured to:
receive information regarding operation of a plurality of wireless connected devices in disparate formats,
analyse the received information regarding each of the plurality of wireless connected devices to generate analytical information regarding each of the plurality of wireless connected devices, and
send the generated analytical information regarding each wireless connected device to a rules module separate from the analytics module, and where the rules module is configured to:
process the generated analytical information for each wireless connected device using predetermined rules, and
send, based on said processing, instructions to carry out a subscriber identity module (SIM) action for that wireless connected device; or a notification regarding that wireless connected device.

11. The system of claim 10, where the analytics module is further configured to harmonize the received information.

12. The system of claim 10, further comprising:
a tracking module separate from the analytics module and the rules module,
where the analytics module is further configured to send location related generated analytical information regarding each wireless connected device to the tracking module,
where the tracking module is configured to:
receive location related generated analytical information regarding each wireless connected device,
process the location related generated analytical information for each wireless connected device to determine a location of that wireless connected device,
compare the determined location to predetermined criteria, and
send, based on said compare, determined location information to the rules module, and
where the rules module is further configured to process the determined location information together with the generated analytical information for each wireless connected device using predetermined rules.

13. The system of claim 12, where the tracking module is further configured to receive tracking information regarding the plurality of wireless connected devices, and process the tracking information together with the location related generated analytical information to determine locations of the wireless connected devices.

14. The system of claim 10, where the analytical information regarding each of the plurality of wireless connected devices is statistical information.

15. The system of claim 10, where:
the plurality of wireless connected devices are arranged into groups of multiple wireless connected devices;
the analytics module is further configured to:
analyse the received information regarding each of the multiple wireless connected devices in a group to generate statistical information regarding the group of wireless connected devices,
compare the generated analytical information regarding a wireless connected device in the group to the statistical information regarding the group of wireless connected devices to identify whether the wireless connected device is operating in an anomalous manner compared to the group of wireless connected devices, and
if the wireless connected device is operating in an anomalous manner, send information that the wireless connected device is operating in an anomalous manner to the rules module; and
the rules module is further configured to process the information that the wireless connected device is operating in an anomalous manner together with the generated analytical information for the wireless connected device.

16. The system of claim 10, where the SIM is an Embedded Universal Integrated Circuit Card (eUICC) enabled SIM (eSIM).

17. The system of claim 10, where the SIM action comprises one or more of:
changing a SIM profile in use by a SIM of the wireless connected device;
shutting down the SIM profile in use by the SIM of the wireless connected device;
changing a tariff associated with the SIM profile of the wireless connected device; and
provisioning a new SIM profile over the air to the SIM of the wireless connected device.

18. The system of claim 10, where the analytics module is further configured to send the generated analytical information regarding different wireless connected devices to different ones of a plurality of distributed rules modules.

19. A non-transitory computer-readable medium storing instructions that, when execute by a processor, cause the processor to perform the method of claim 1.
